(19) United States
(12) Patent Application Publication
(10) Pub. No.: US 2017/0017913 A1
(43) Pub. Date: Jan. 19, 2017

(54) MANAGING DATA QUALITY AND COMPLIANCE

(71) Applicant: International Business Machines Corporation, Armonk, NY (US)

(72) Inventors: Harish Bharti, PUNE (IN); Kshitij K. Raval, PUNE (IN); Pranshu Tiwari, New Delhi (IN)

(21) Appl. No.: 14/802,547

(22) Filed: Jul. 17, 2015

(51) Int. Cl. G06Q 10/06; G06Q 30/00; G06F 17/30

(52) U.S. Cl. CPC G06Q 10/06393; G06F 17/30303; G06Q 10/0635; G06Q 30/018

(57) ABSTRACT

In an approach to managing data quality and compliance, a computer retrieves data within a business enterprise system. The computer applies a set of rules to the data, wherein the application of the set of rules to the data produces a plurality of mapped data, and the computer aggregates the plurality of mapped data into a plurality of results. The computer then reports the plurality of results for a data display.

### BACKGROUND OF THE INVENTION

The present invention relates generally to the field of data quality management, and more particularly to managing data quality and compliance.

Managing data quality can be important for organizations, as poor data quality, or ambiguous data quality, usually leads to high costs. Comparing a current data quality level with a required data quality level is necessary for effective data quality management. Additionally, business organizations and business enterprise systems monitor data quality with respect to compliance with respective regulatory authorities. The required data quality level may be determined within an organization, or by the respective regulatory agency.

### SUMMARY

Embodiments of the present invention disclose a method, a computer program product, and a computer system for managing data quality and compliance. The method may include one or more computer processors retrieving data within a business enterprise system. The one or more computer processors apply a set of rules to the data, wherein the application of the set of rules to the data produces a plurality of mapped data, and aggregate the plurality of mapped data into a plurality of results. The one or more computer processors report the plurality of results for a data display.

### BRIEF DESCRIPTION OF THE DRAWINGS

FIG. 1 is a functional block diagram illustrating a data processing environment, in accordance with an embodiment of the present invention;

FIG. 2 is a flowchart depicting operational steps of an analysis module, for retrieving, processing, and reporting data for a data display, in accordance with an embodiment of the present invention;

FIG. 3 is a flowchart depicting operational steps of a rules engine, for applying a set of rules to processed data and deriving data for a data display, in accordance with an embodiment of the present invention; and

FIG. 4 is a block diagram of components of a data processing system, such as the server computing device of FIG. 1, in accordance with an embodiment of the present invention.

### DETAILED DESCRIPTION

Embodiments of the present invention recognize that ambiguity and poor quality of data used in understanding a business value of the data has a large impact within an organization or business enterprise system. Embodiments of the present invention provide a framework to prioritize an organizations focus on data quality based on a probability of an occurrence of a data quality issue and a business value impact of the data quality issue.

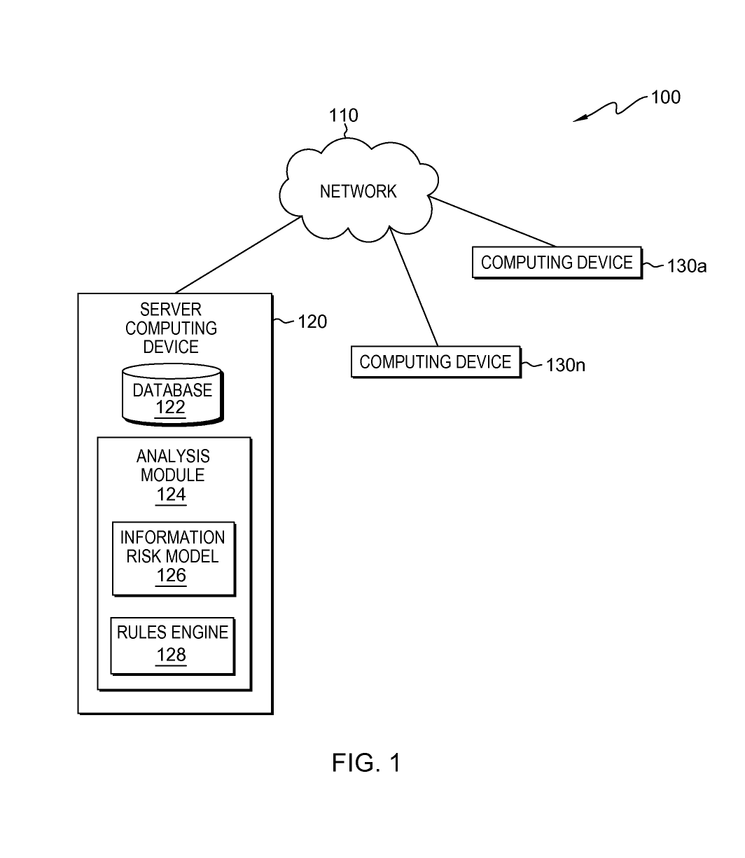

The present invention will now be described in detail with reference to the Figures. FIG. 1 is a functional block diagram illustrating a data processing environment, generally designated 100, in accordance with one embodiment of the present invention. FIG. 1 provides only an illustration of one implementation and does not imply any limitations with regard to the environments in which different embodiments may be made by those skilled in the art without departing from the scope of the invention as recited by the claims.

Data processing environment 100 includes server computing device 120 and computing device(s) 130a to 130n, interconnected via network 110. Network 110 can be, for example, a telecommunications network, a local area network (LAN), a wide area network (WAN), such as the Internet, or a combination of the three, and can include wired, wireless, or fiber optic connections. Network 110 may include one or more wired and/or wireless networks that are capable of receiving and transmitting data, voice, and/or video signals, including multimedia signals. In general, network 110 can be any combination of connections and protocols that will support communications between server computing device 120, each of computing device(s) 130a to 130n, and other computing devices (not shown) within data processing environment 100.

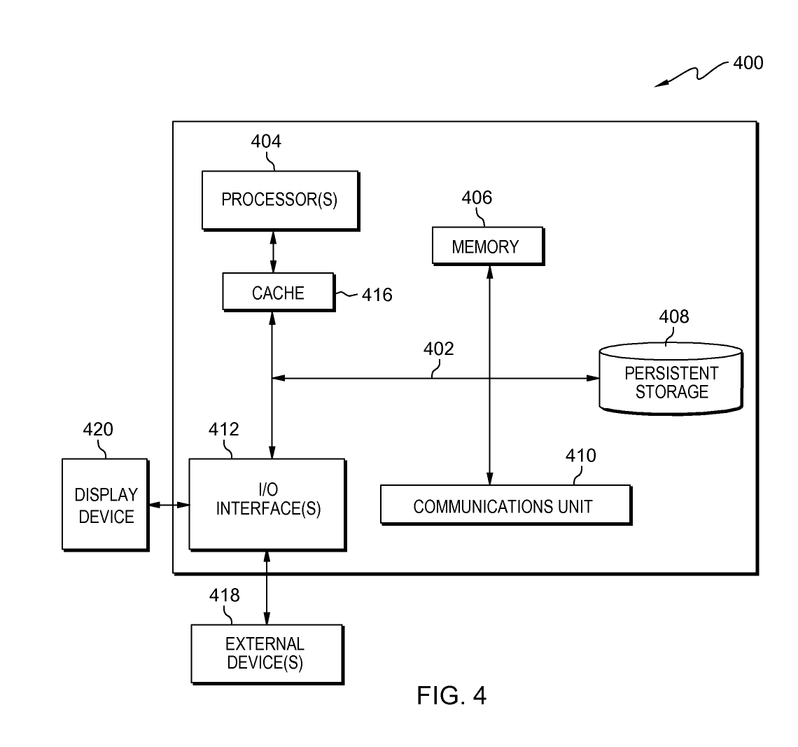

In various embodiments, server computing device 120 can be a standalone computing device, a management server, a web server, a mobile computing device, or any other electronic device or computing system capable of receiving, sending, and processing data. In other embodiments, server computing device 120 can represent a server computing system utilizing multiple computers as a server system. In another embodiment, server computing device can be a laptop computer, a tablet computer, a netbook computer, a personal computer, a desktop computer, or any programmable electronic device capable of communicating with other computing devices (not shown) within data processing environment 100 via network 110. In another embodiment, server computing device 120 represents a computing system utilizing clustered computers and components (e.g., database server computers, application server computers, etc.) that act as a single pool of seamless resources when accessed within data processing environment 100. Server computing device 120 includes database 122 and analysis module 124. In various embodiments, each of the programs, modules, and/or database included on server computing device 120 may be located elsewhere within data processing environment 100 with access to data and information for implementation of the present invention via network 110. Server computing device 120 may include internal and external hardware components, as depicted and described with respect to computer system 400 of FIG. 4.

Database 122 resides on server computing device 120. A database is an organized collection of data. Database 122 can be implemented with any type of storage device capable of storing data that can be accessed and utilized by server computing device 120, such as a database server, a hard disk drive, or a flash memory. In other embodiments, database 122 can represent multiple storage devices within data processing environment 100 or within server computing device 120. Database 122 stores information received from each utility or business organization, for example, each of computing device(s) 130a to 130n. In an embodiment, database 122 stores information processed and reported by analysis module 124. In some embodiments, database 122 can store information inputted by a client or customer within data processing environment 100, such as, for example, direct and indirect consequences due to data quality issues, one or more probability levels associated with an impact of the consequences, or historical data regarding a data quality issue. Database 122 can also store derived data from operation of rules engine 128.

Analysis module 124 provides a method for managing data quality and compliance within a business enterprise system or organization. Analysis module 124 retrieves and processes data within a business enterprise system, for example, within data processing environment 100. A business enterprise system may be a combination of hardware and software used by a business and the enterprises composing the business to organize and run the business operations. Such an enterprise system may manage more than one operation, utility, or asset, for a company to facilitate its business and management reporting needs. Analysis module 124 applies a rule engine, such as rules engine 128, to the processed data, and when the data is processed and mapped by rules engine 128, analysis module 124 performs various checks on the data, aggregates the results, and provides a data display as a service specific to each utility enrolled, for example, computing device(s) 130a to 130n. Rules engine 128 retrieves data quality issues for the processed data, and determines a probability level of any consequences of the data quality issues, and direct and indirect impacts of the consequences of the data. Rules engine 128 maps the business impact value of the data, as determined based on direct and indirect consequences of each data quality issue, to each compliance parameter for the business enterprise system. Information Risk Model (“IRM”) 126 contains an information problem, an information quality problem, direct consequences, indirect consequences, and a business value impact of each data quality problem on regulatory data output. Each of the direct consequences, indirect consequences and business value impacts can be determined based on input from the utility or business providing the data.

In various embodiments, computing device(s) 130a to 130n can each be a laptop computer, a tablet computer, a smartphone, or any programmable electronic device capable of communicating with server computing device 120 via network 110, and with various components and devices (not shown) within data processing environment 100. In general, computing device(s) 130a to 130n represent any programmable electronic device capable of executing machine readable program instructions and communication with other computing devices via a network, such as network 110. In an embodiment, computing device(s) 130a to 130n each represent a business or a utility present within a business enterprise system, and provide data to server computing device 120 from, for example, an enterprise asset management system, a project planning system, and a financial system. In one embodiment, computing device(s) 130a to 130n each consume the data display provided by analysis module 124 as a service.

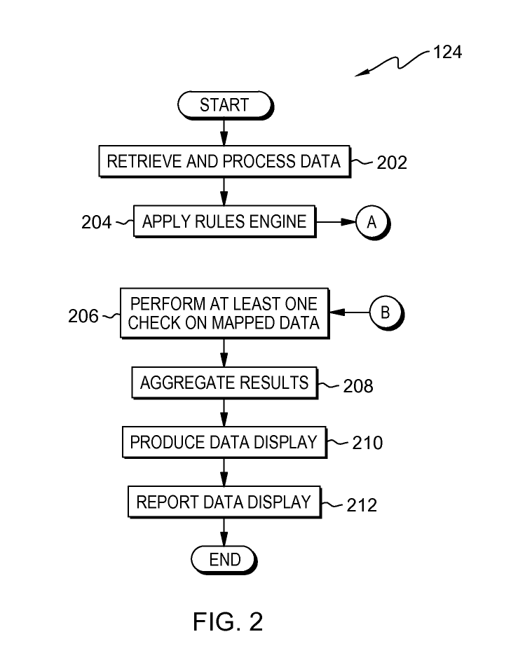

FIG. 2 is a flowchart depicting operational steps of analysis module 124 for retrieving, processing, and reporting data for a data display, in accordance with an embodiment of the present invention.

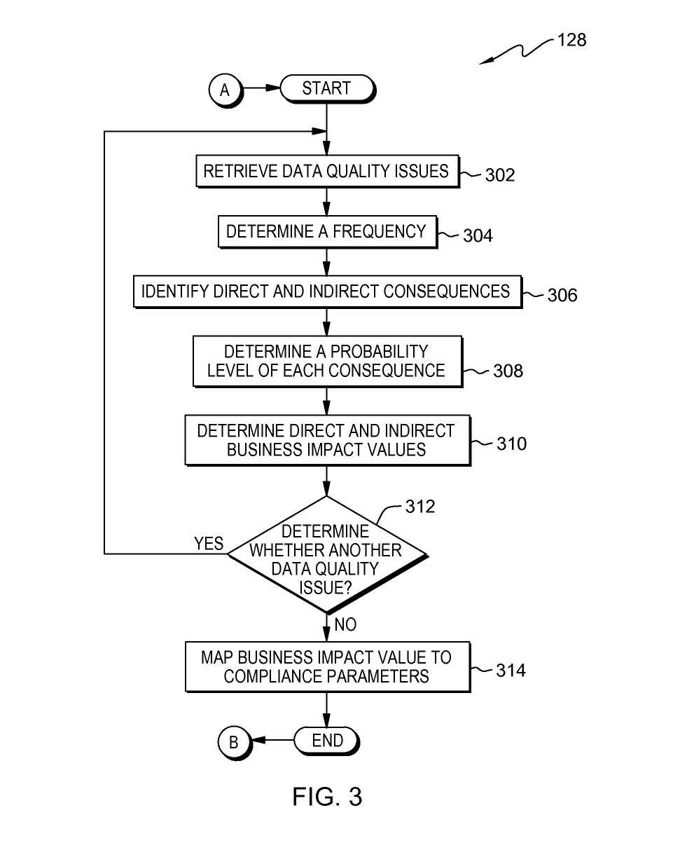

Analysis module 124 retrieves and processes data (step 202). Data is provided by each of a plurality of utilities, for example, computing device(s) 130a to 130n. Analysis module 124 processes the data and stores the data, for example, in IRM 126. Analysis module 124 applies a rules engine (step 204). The rules engine, such as rules engine 128, is applied to the processed data in IRM 126 to produce a plurality of mapped data. The rules engine operation is discussed further with reference to FIG. 3.

Analysis module 124 performs at least one check on mapped data (step 206). The plurality of mapped data obtained through use of rules engine 128 is checked, for example, for accuracy and for financial impact. In embodiments, analysis module 124 may receive guidelines as input from a business or organization, such guidelines used to aid with determining and checking the accuracy and financial impact of the data quality issues mapped to compliance parameters. A check on the data may be, for example, an accuracy check of calculations as compared with the data provided, or verifying the correct data is mapped to the proper compliance parameters for the utility providing the data. Analysis module 124 aggregates results (step 208) in order to produce a data display (step 210). In embodiments, analysis module 124 aggregates results for each utility, or for each compliance parameter, or some other category, and produces a display of the data for that category. In other embodiments, analysis module 124 may report the data to another program or module within data processing environment 100 (not shown) for display.

Analysis module 124 reports the data display (step 212). The data display, for example, a dashboard display, can depict each of the calculated impacts due to any data quality issues with the data provided, such as financial or business value impacts. The data display may also depict safety, reliability and environmental impact values due to any data quality issues, and a range of potential impacts, such as low impact to high impact. In embodiments, the data display may provide direction to an organization faced with meeting regulatory compliance requirements and a set of data quality issues that may be impacting the compliance requirements. For example, analysis module 124 may report a data display that indicates a rare data quality issue is quite costly, but a more frequent data quality issue is less costly, and an organization can then proceed with an action based on its business plan. The display of data may be viewed on a user interface on a client device, for example, computing device(s) 130a to 130n, in order to perform risk assessment evaluations or business value reporting. In an embodiment, IRM 126 may be used to display the mapped data.

FIG. 3 is a flowchart depicting operational steps of rules engine 128 for applying a set of rules to processed data and deriving data for a data display, in accordance with an embodiment of the present invention.

Rules engine 128 retrieves data quality issues (step 302). Data quality issues exist across a business enterprise system, and can deal with, for example, the consistency or correctness of the data across the enterprise. Rules engine 128 determines a frequency (step 304). The frequency can be based on historical data, and is an occurrence of a data quality issue across a set of data. For example, two of 100 data elements may have an inconsistent data point across different systems, while one of the 100 may not have the current data point. The data quality problems therefore can be either inconsistency, currency, or both. Each of the consistency and the currency, or most recent data, are independent of the frequency. In various embodiments, the frequency can be used to determine a probability of an occurrence of a data quality issue within a set of data. In an embodiment, frequency can be determined within a provided data set, and is different for each different data quality item. For example, a currency data quality issue may have a frequency of 2% across data within a data set. A currency data quality issue may have a direct consequence on a delay of construction, which may lead to a delay of work, which may lead to a negative issue with customer satisfaction.

Rules engine 128 identifies direct and indirect consequences (step 306). An indirect consequence may be considered a potential impact due to the data quality issue. Consequences due to data quality problems may vary based on hierarchical levels of management and operation in a business enterprise system. For example, a data quality problem having an impact at a warehouse level may or may not impact operations at a senior management level. In various embodiments, the consequences of a data quality problem, for example, poor data quality, are entered into a rules based engine, for example, rules engine 128, based on discussions with the business enterprise system, or business organization. In an embodiment, rules engine 128 is able to apply one or more consequences due to a data quality issue at various levels within an organization or business enterprise system, by computing an overall consequence at one level, and then carrying that consequence through to the various other levels.

Rules engine 128 determines a probability level of each consequence (step 308). A probability level is a variable which varies for each different data quality issue, each level of consequence, and each type of consequence. Each flaw in a data item has a probability to cause a direct or an indirect consequence, which can impact a business objective or a regulatory objective for a client. In various embodiments, the probability level of each consequence is based on expert based knowledge and judgment on whether a data quality issue may have a potential impact on a customer or stakeholder. In some embodiments, the probability of the consequence is based on historical data, a subject of the data quality issue, and financial impacts in a previous time period. For example, a commissioned asset is not tagged correctly in a maintenance schedule, where each asset number involved is in the maintenance schedule. An incorrectly tagged asset may result in incorrect asset maintenance, which can impact the safety and reliability of a transmission line. In an embodiment, based on the historical data, rules engine 128 can determine whether the probability level of a safety consequence due to a data quality issue is higher than a probability level of a financial consequence due to a data quality issue.

The probability level varies based on the data quality issue, and the consequence of the data quality issue. For a type of consequence, n, and a level of consequence, m, (direct consequence or indirect consequence), the probability level of a consequence due to a data quality issue can be calculated based on the frequency of the data quality issue, the probability of impact due to the problem, and the business value of the data. In an embodiment, frequency can be determined within a provided data set, and is different for each different data quality item. Rules engine 128 applies the probability levels to various data, as provided by each utility within an organization or business enterprise system, and generates a hierarchical relationship of consequences of each data quality issue. The hierarchical relationship of consequences, direct, indirect, and at varying levels, can provide a view of data quality to management.

In an example, a probability level varies depending on the consequence and the data quality issue. A total probability level across each level of an organization may include determining the probability of a direct consequence, DC, and corresponding indirect consequences, IDC, at each level individually, using the frequency of the data quality issue, f, and the probability, p. One manner by which to calculate the probability of a DC may be to sum the product of each the f and p at each level, i.e., using the consequence at each level. Knowing there is a currency data quality issue with data item A, a frequency of 2% of the data quality issue, a direct consequence of a delay of work with a 10% probability, and an indirect consequence of a project closure delay with a 20% probability, rules engine 128 can determine a probability of the direct consequence by determining (2%*10%)+(2%*20%). The business impact value of the known data quality issue may be a financial impact value of a cost loss, or a loss in customer satisfaction. One skilled in the art will appreciate that the above example is only example of a probability level calculation, and that there may be other methods and computations to determine a probability level for each consequence due to a data quality issue within a set of data.

Rules engine 128 determines direct and indirect business impact values (step 310). A direct business impact value is a value of a consequence due to the particular data quality issue. A direct business impact is measured from the direct consequence due to the data quality problem of the data item. Every direct business impact may have an indirect business impact on compliance. Direct and indirect business impacts are determined and measured based on discussions with a business enterprise or organization, and are configured within rules engine 128. For example, inconsistent data on a time of delivery may have a consequence of a failed delivery, which may directly impact project management, and may indirectly impact customer satisfaction. The value of each business impact is discussed with the business enterprise or organization, including penalizations to the business due to the data quality problem. Each business enterprise system or organization may have independent considerations and rankings for business impact values, including safety impact values, environmental impact values, or financial impact values.

Rules engine 128 determines whether another data quality issue is present (decision step 312). If rules engine 128 determines another data quality issue is present, for example, a currency issue (decision step 312, “yes” branch), then rules engine 128 returns to retrieve the data quality issue (step 302). If rules engine 128 determines there is no additional data quality issue present (decision step 312, “no” branch), then rules engine 128 maps a business impact value to each compliance parameter (step 314). One or more compliance parameters are known to the business enterprise or organization, and are input into rules engine 128. Rules engine 128 determines whether a determined business impact value corresponds to at least one compliance parameter, and if so, maps the business impact value to the compliance parameter. The mapped data results are then provided to analysis module 124 for aggregation and display. In embodiments, a regulatory authority provides the compliance parameters and details to the business enterprise or utility within certain sectors, for example, an energy and utility sector.

FIG. 4 depicts a block diagram of components of a computer system 400, which is an example of a system such as server computing device 120 of FIG. 1, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computer system 400 includes computer processors(s) 404, cache 416, memory 406, persistent storage 408, communications unit 410, input/output (I/O) interface(s) 412, and communications fabric 402. Communications fabric 402 provides communications between cache 416, memory 406, persistent storage 408, communications unit 410, and I/O interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM). In general, memory 406 can include any suitable volatile or non-volatile computer readable storage media. Cache 416 is a memory that enhances the performance of processor(s) 404 by storing recently accessed data, and data near recently accessed data, from memory 406.

Program instructions and data used to practice embodiments of the present invention, e.g., database 122 and analysis module 124 can be stored in persistent storage 408 for execution and/or access by one or more of the respective computer processor(s) 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices, including with computing devices 130a to 130n within data processing environment 100. In these examples, communications unit 410 includes one or more network interface cards. Communications unit 410 may provide communications through the use of either or both physical and wireless communications links. Program instructions and data used to practice embodiments of the present invention may be downloaded to persistent storage 408 through communications unit 410.

I/O interface(s) 412 allows for input and output of data with other devices that may be connected to computer system 400. For example, I/O interface(s) 412 may provide a connection to external device(s) 418 such as a keyboard, a keypad, a touch screen, and/or some other suitable input device. External device(s) 418 can also include portable computer readable storage media such as, for example, thumb drives, portable optical or magnetic disks, and memory cards. Software and data used to practice embodiments of the present invention can be stored on such portable computer readable storage media and can be loaded onto persistent storage 408 via I/O interface(s) 412. I/O interface(s) 412 also connect to a display 420. Display 420 provides a mechanism to display data to a user and may be, for example, a computer monitor or an incorporated display screen, such as is used, for example, in tablet computers and smart phones.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for managing data quality and compliance, the method comprising:
retrieving, by one or more computer processors, data within a business enterprise system;
applying, by one or more computer processors, a set of rules to the data, wherein the application of the set of rules to the data produces a plurality of mapped data;
aggregating, by one or more computer processors, the plurality of mapped data into a plurality of results; and
reporting, by one or more computer processors, the plurality of results for a data display.

2. The method of claim 1, wherein applying the set of rules to the data further comprises:
retrieving, by one or more computer processors, one or more data quality issues;
identifying, by one or more computer processors, at least one consequence of the one or more data quality issues; and
determining, by one or more computer processors, a probability level of each consequence of the one or more data quality issues, wherein the probability level is based, at least in part, on a frequency of the one or more data quality issues.

3. The method of claim 2, further comprising:
determining, by one or more computer processors, at least one business impact value due to the at least one consequence; and
mapping, by one or more computer processors, the at least one business impact value of the one or more data quality issues to a plurality of compliance parameters.

4. The method of claim 3, wherein the plurality of compliance parameters include at least one compliance parameter from a regulatory authority.

5. The method of claim 1, wherein reporting the plurality of results for a data display further comprises:
retrieving, by one or more computer processors, one or more data quality issues; and
displaying, by one or more computer processors, at least one business impact value due to the one or more data quality issues.

6. The method of claim 5, wherein the at least one business impact value is one or more of a financial impact value, an environmental impact value, and a safety impact value.

7. The method of claim 1, wherein retrieving data within the business enterprise system further comprises retrieving, by one or more computer processors, data from at least one utility within the business enterprise system.

8. The method of claim 1, further comprising:
performing, by one or more computer processors, at least one check on the plurality of mapped data, wherein the at least one check is at least an accuracy check.

9. A computer program product for managing data quality and compliance, the computer program product comprising:
one or more computer readable storage device and program instructions stored on the one or more computer readable storage device, the stored program instructions comprising:
program instructions to retrieve data within a business enterprise system;
program instructions to apply a set of rules to the data, wherein the application of the set of rules to the data produces a plurality of mapped data;
program instructions to aggregate the plurality of mapped data into a plurality of results; and
program instructions to report the plurality of results for a data display.

10. The computer program product of claim 9, wherein the stored program instructions to apply a set of rules to the data comprise:
program instructions to retrieve one or more data quality issues;
program instructions to identify at least one consequence of the one or more data quality issues; and
program instructions to determine a probability level of each consequence of the one or more data quality issues, wherein the probability level is based, at least in part, on a frequency of the one or more data quality issues.

11. The computer program product of claim 10, further comprising:
program instructions to determine at least one business impact value due to the at least one consequence; and
program instructions to map the at least one business impact value of the one or more data quality issues to a plurality of compliance parameters.

12. The computer program product of claim 9, wherein the stored program instructions to report the plurality of results for a data display comprise:
program instructions to retrieve one or more data quality issues; and
program instructions to display at least one business impact value due to the one or more data quality issues.

13. The computer program product of claim 12, wherein the at least one business impact value is one or more of a financial impact value, an environmental impact value, and a safety impact value.

14. The computer program product of claim 9, wherein the stored program instructions to retrieve data within the business enterprise system comprise program instructions to retrieve data from at least one utility within the business enterprise system.

15. A computer system for managing data quality and compliance, the computer system comprising:
one or more computer processors;
one or more computer readable storage device;
program instructions stored on the one or more computer readable storage device for execution by at least one of the one or more computer processors, the stored program instructions comprising:
program instructions to retrieve data within a business enterprise system;
program instructions to apply a set of rules to the data, wherein the application of the set of rules to the data produces a plurality of mapped data;
program instructions to aggregate the plurality of mapped data into a plurality of results; and
program instructions to report the plurality of results for a data display.

16. The computer system of claim 15, wherein the stored program instructions to apply a set of rules to the data comprise:
program instructions to retrieve one or more data quality issues;
program instructions to identify at least one consequence of the one or more data quality issues; and
program instructions to determine a probability level of each consequence of the one or more data quality issues, wherein the probability level is based, at least in part, on a frequency of the one or more data quality issues.

17. The computer system of claim 16, further comprising:
program instructions to determine at least one business impact value due to the at least one consequence; and
program instructions to map the at least one business impact value of the one or more data quality issues to a plurality of compliance parameters.

18. The computer system of claim 15, wherein the stored program instructions to report the plurality of results for a data display comprise:
program instructions to retrieve one or more data quality issues; and
program instructions to display at least one business impact value due to the one or more data quality issues.

19. The computer system of claim 18, wherein the at least one business impact value is one or more of a financial impact value, an environmental impact value, and a safety impact value.

20. The computer system of claim 15, wherein the stored program instructions to retrieve data within the business enterprise system comprise program instructions to retrieve data from at least one utility within the business enterprise system.
